(19) United States
(12) Patent Application Publication
(10) Pub. No.: US 2014/0255760 A1
(43) Pub. Date: Sep. 11, 2014

(54) BATTERY PACK AND BATTERY MODULE INCLUDING THE SAME

(71) Applicants: ROBERT BOSCH GMBH, Stuttgart (DE); SAMSUNG SDI CO., LTD., Yongin-si (KR)

(72) Inventor: Min-Yeol Han, Yongin-si (KR)

(73) Assignees: ROBERT BOSCH GMBH, Stuttgart (DE); SAMSUNG SDI CO., LTD., Yongin-si (KR)

(21) Appl. No.: 14/011,741

(22) Filed: Aug. 27, 2013

(30) Foreign Application Priority Data
Mar. 5, 2013 (KR) 10-2013-0023563

(51) Int. Cl. H01M 10/02

(52) U.S. Cl. CPC H01M 10/02
USPC 429/157

(57) ABSTRACT

A battery pack includes a plurality of six-sided first batteries arranged so that first surfaces of neighboring ones of the first batteries contact each other, and a second battery including a surface that extends in a direction in which the first batteries are arranged, and that contacts second surfaces of the first batteries, wherein the first surfaces of the first batteries have a larger surface area than the second surfaces of the first batteries.

### CROSS-REFERENCE TO RELATED APPLICATION

This application claims priority to and the benefit of Korean Patent Application No. 10-2013-0023563, filed on Mar. 5, 2013, in the Korean Intellectual Property Office, the disclosure of which is incorporated herein in its entirety by reference.

### BACKGROUND

1. Field

One or more embodiments of the present invention relate to a battery pack and a battery module including the battery pack.

2. Description of the Related Art

In general, secondary batteries are rechargeable, and capable of being used repeatedly. Electric tools requiring a relatively small amount of electric power use a battery pack in which a plurality of secondary batteries are combined. In addition, a battery module, in which a plurality of battery packs are connected, can supply electric power to drive a motor in hybrid electric vehicles (HEVs) or electric vehicles (EV) requiring a relatively large amount of electric power.

Such battery packs or battery modules are manufactured by mechanically coupling and electrically connecting a plurality of batteries to each other. When the battery pack or the battery module described above is used for an extended period of time, a swelling phenomenon may occur in the batteries, and stress may be concentrated on a part of components. Also, due to external shock, some of the batteries in the battery pack or the battery module may be partially deformed, thereby potentially increasing force transferred to other batteries. Accordingly, over time, the battery pack or the battery module may be deformed, or electric performance of the battery pack or the battery module may be degraded.

### SUMMARY

One or more embodiments of the present invention include a battery pack capable of stably maintaining an overall structure even when some batteries are damaged due to external shock or to long-term use, and a battery module including the battery pack.

One or more embodiments of the present invention include a battery pack capable of maintaining electrical performance by dispersing force applied to individual batteries, and by ensuring mechanical stability, even when the number of batteries in the battery pack or the battery module for supplying a large amount of electric power is relatively large, and a battery module including the battery pack.

Additional aspects will be set forth in part in the description which follows and, in part, will be apparent from the description, or may be learned by practice of the presented embodiments.

According to one or more embodiments of the present invention, a battery pack includes a plurality of six-sided first batteries arranged so that first surfaces of neighboring ones of the first batteries contact each other, and a second battery including a surface that extends in a direction in which the first batteries are arranged, and that contacts second surfaces of the first batteries, wherein the first surfaces of the first batteries have a larger surface area than the second surfaces of the first batteries.

The second battery may include six surfaces comprising the surface, and the surface of the second battery may have a largest surface area from among the six surface of the second battery.

The battery pack may further include a third battery contacting third surfaces of the first batteries opposite the second surfaces of the first batteries.

The third battery may include six surfaces, and one of a largest of the six surfaces of the third battery may contact the third surfaces of the first batteries.

The battery pack may further include a conductive tab electrically connected to terminals of the first batteries, the second battery, and the third battery.

The first batteries may each further include terminals at a fourth surface or a fifth surface extending between the second surface and third surface.

The battery pack may further include a housing surrounding a part of the first batteries, the second battery, and the third battery.

The housing may include a through hole configured to allow air to pass therethrough.

The battery pack may further include a spacer between the neighboring ones of the first batteries, or between the first batteries and the second battery.

The spacer may include a through hole configured to allow air to pass therethrough.

According to another aspect of the present invention, a battery module includes a plurality of battery packs, each of the battery packs including a plurality of six-sided first batteries arranged so that first surfaces of neighboring ones of the first batteries contact each other, the first surfaces having a largest area among six surfaces of the first batteries, and a second battery including a surface contacting second surfaces of the first batteries and extending in a direction in which the first batteries are arranged, and a housing surrounding and supporting the battery packs.

Each of the battery packs may further include a third battery contacting third surfaces of the first batteries that are opposite the second surfaces of the first batteries.

The first batteries, the second battery, and the third battery may be similarly dimensioned.

The second and third batteries of neighboring ones of the battery packs may extend in a direction in which the first batteries are arranged.

The second battery and the third battery of one of the battery packs may have substantially equal lengths in the direction in which the first batteries are arranged, and a combined width of the first batteries of the one of the battery packs may be less than or equal to the lengths of the second and third batteries.

One of the first batteries of one of the battery packs may extend past an edge of the second battery or of the third battery of the one of the battery packs, and may contact the second battery or the third battery of an adjacent one of the battery packs.

### BRIEF DESCRIPTION OF THE DRAWINGS

These and/or other aspects of embodiments of the present invention will become apparent and more readily appreciated from the following description, taken in conjunction with the accompanying drawings of which:

FIG. 1 is an exploded perspective view of a battery pack according to an embodiment of the present invention;

FIG. 2 is an exploded perspective view of a battery pack according to another embodiment of the present invention;

FIG. 3 is an exploded perspective view showing a stacked structure of the battery pack shown in FIG. 2;

FIG. 4 is a conceptual view showing an operating state of the battery pack shown in FIG. 2;

FIG. 5 is a conceptual view showing another operating state of the battery pack shown in FIG. 2;

FIG. 6 is a schematic front view of a battery module according to another embodiment of the present invention;

FIG. 7 is a schematic front view of a battery module according to another embodiment of the present invention;

FIG. 8 is a schematic front view of a battery module according to another embodiment of the present invention;

FIG. 9 is a schematic front view of a battery module according to another embodiment of the present invention;

FIG. 10 is an exploded perspective view showing a stacked structure of batteries in a battery pack according to another embodiment of the present invention;

FIG. 11 is an exploded perspective view showing a stacked structure of batteries in a battery pack according to another embodiment of the present invention.

### DETAILED DESCRIPTION

Reference will now be made in detail to embodiments of the present invention, examples of which are illustrated in the accompanying drawings, wherein like reference numerals refer to the like elements throughout. In this regard, the present embodiments may have different forms and should not be construed as being limited to the descriptions set forth herein. Exemplary embodiments are merely described below by referring to the figures to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

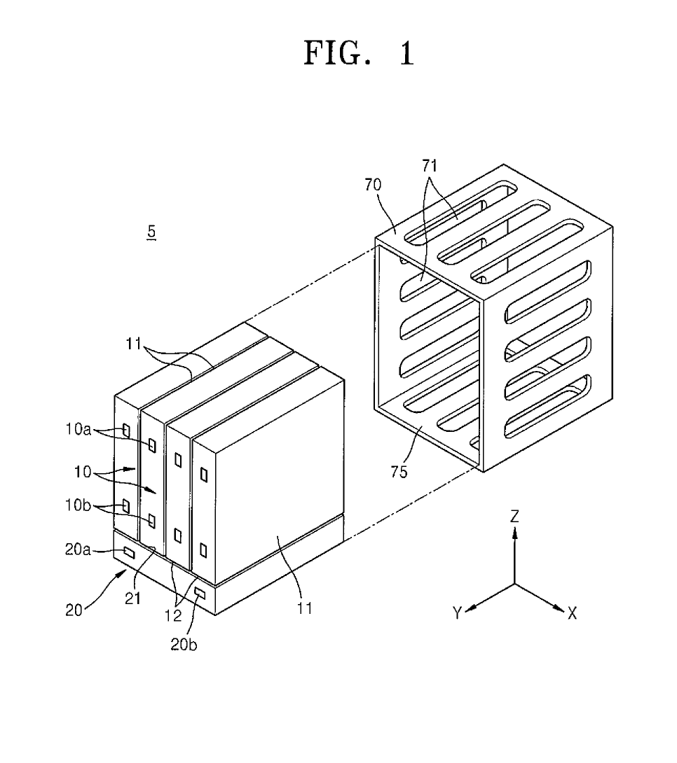

FIG. 1 is an exploded perspective view schematically showing a battery pack 5 according to an embodiment of the present invention. The battery pack 5 includes first batteries 10 having first surfaces (e.g., side surfaces) 11 contacting each other, and a second battery 20 located to contact at least some parts of second surfaces (e.g., bottom surfaces) 12 of the first batteries 10.

Each of the first batteries 10 in the battery pack 5 includes six surfaces. In FIG. 1, the first batteries 10 are formed to have rectangular parallelepiped shapes. Each of the first batteries 10 includes an opposing pair of first surfaces 11 that have the largest areas among the six surfaces. The plurality of first batteries 10 are arranged so that respective ones of the first surfaces 11 of neighboring first batteries 10 contact each other.

In the present embodiment, the second battery 20 also includes six surfaces, and is also formed to have a rectangular parallelepiped shape. The second battery 20 includes a surface 21 (e.g., a top surface that is similar to the first surfaces 11 of the first batteries 10) extending along a direction in which the first batteries 10 are arranged (X-axis direction in FIG. 1). The surface 21 may be one of a pair of surfaces having the largest areas from among the six surfaces of the second battery 20 formed as the rectangular parallelepiped.

The second battery 20 is located so that the surface 21 of the second battery 20 contact at least some parts of the second surfaces 12 of the first batteries 10. The second surface 12 of the each first battery 10 may be one of the surfaces forming edges of the first battery 10 (e.g., bottom edges/second surfaces 12 of the first battery 10 with respect to the Z-axis shown in FIG. 1).

The battery pack 5 may include a housing 70 surrounding the plurality of first batteries 10 and the second battery 20. When the plurality of first batteries 10 and the second battery 20 are stacked as shown in FIG. 1, the combined stack of the first batteries 10 and the second battery 20 is inserted into an accommodation space 75 of the housing 70, thereby assembling the battery pack 5.

In FIG. 1, four first batteries 10 are used, and each of the first batteries 10 has the same shape as the second battery 20. However, embodiments of the present invention are not limited to the above number of the first batteries 10, or to the shapes of the first and second batteries 10 and 20, that is, the number of the first batteries 10 and the shapes of the first and second batteries 10 and 20 may be modified variously. For example, three, five, or more first batteries 10 may be stacked, and the second battery 20 may have a thickness in the Z-axis direction that is greater than or less than the individual widths in the X-axis direction of the first batteries 10.

The housing 70 of the present embodiment may be formed of a metal material, such as aluminum, or may be formed of a plastic material. The housing 70 surrounds the first batteries 10 and the second battery 20 of the battery pack 5 to protect and support the first and second batteries 10 and 20. The housing 70 may include a first through hole 71 through which air passes.

Each of the first batteries 10 and the second battery 20 may respectively include terminals 10a and 10b, and 20a and 20b. When the first batteries 10 and the second battery 20 are inserted in the housing 70, electrically conductive tabs may be coupled to the terminals 10a, 10b, 20a, and 20b.

In the present embodiment, the second battery 20 in the battery pack 5 contacts the edges 12 of the first batteries 10 to disperse loads/forces. Therefore, when compared with a case where the battery pack is manufactured by stacking the first batteries only, the structure of the first and second batteries 10 and 20 that are arranged in different directions from each other may disperse the load, or force, applied to the battery pack 5.

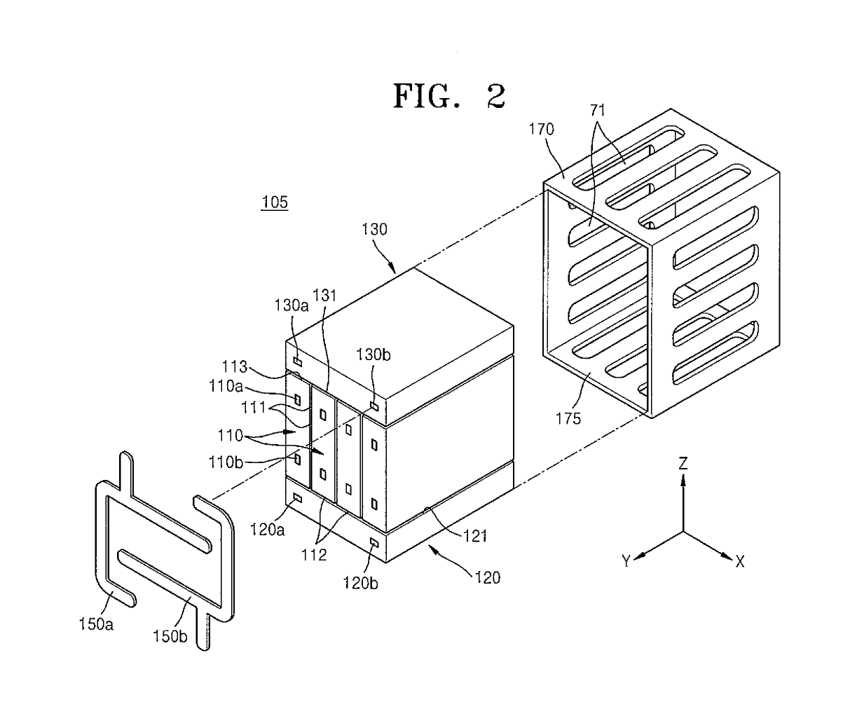

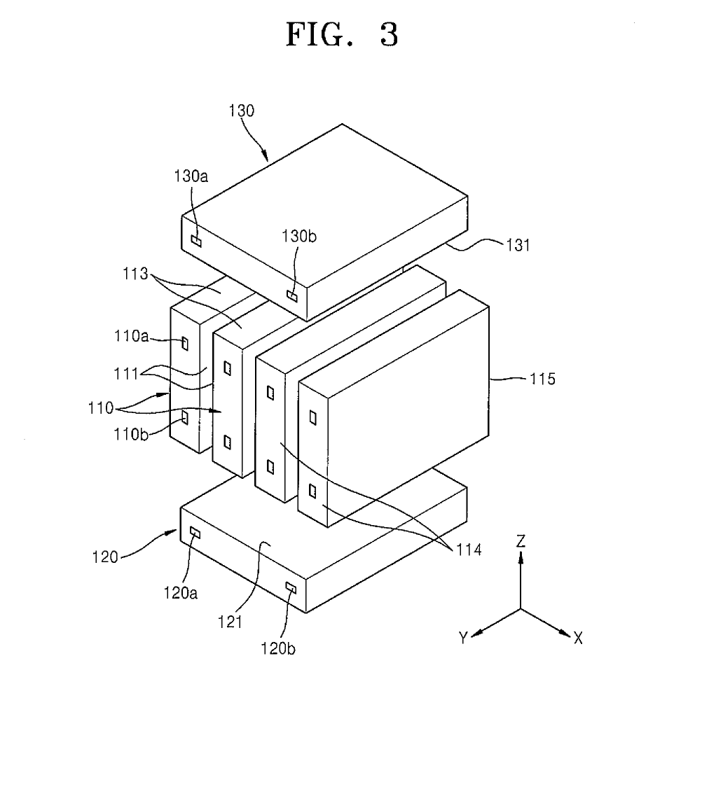

FIG. 2 is an exploded perspective view schematically showing a battery pack 105 according to another embodiment of the present invention, and FIG. 3 is an exploded perspective view showing a stacked structure of the battery pack 105.

Referring to FIGS. 2 and 3, the battery pack 105 includes first batteries 110, respective first surfaces 111 of neighboring ones of which contact each other, a second battery 120 contacting at least some parts of second surfaces 112 of the first batteries 110, and a third battery 130 contacting at least some parts of third surfaces (e.g., top surfaces) 113 of the first batteries 110.

Each of the first batteries 110 in the battery pack 105 includes six surfaces and is shaped as a rectangular parallelepiped. Each of the first batteries 110 includes a pair of first surfaces 111 that have the largest areas among the six surfaces and that face each other. The plurality of first batteries 110 are arranged in an X-axis direction so that the respective ones of the first surfaces 111 thereof contact each other.

The second battery 120 is also formed as a rectangular parallelepiped having six surfaces. The second battery 120 includes a surface 121 that extends in a direction (e.g., an X-axis direction) in which the first batteries 110 are arranged/ordered. The surface 121 of the second battery 120 is one of a pair of the largest surfaces from among the six surfaces of the second battery 120.

The second battery 120 is oriented so that the surface 121 of the second battery 120 contacts at least some parts of the second surfaces 112 of the first batteries 110. The second surface 112 in each of the first batteries 110 may be one of the surfaces forming edges 112 of the first battery 110 having the rectangular parallelepiped shape.

The surface 121 of the second battery 120 contacts at least some parts of the second surfaces 112 of the first batteries 110, because the first batteries 110 may be deformed due to loads thereof, or because the first batteries 110 may be differently sized due to manufacturing tolerances. That is, when the first batteries 110 and the second battery 120 are stacked as shown in FIG. 2, one of the first batteries 110 may be deformed, or may have a size different from other first batteries 110 due to the manufacturing tolerance, and in this case, the corresponding first battery 110 might not contact the surface 121 of the second battery 120.

The third battery 130 is located to contact at least some parts of third surfaces 113 of the first batteries 110, wherein the third surfaces 113 are opposite to the second surfaces 112.

The third battery 130 is formed to be a rectangular parallelepiped having six surfaces. The third battery 130 includes a surface (e.g., bottom surface) 131 that extends in a direction (e.g., X-axis direction) in which the first batteries 110 are arranged. The surface 131 of the third battery 130 may be one of a pair of the largest surfaces from among the six surfaces of the third battery 130.

The battery pack 105 may include a housing 170 for surrounding the plurality of first batteries 110, the second battery 120, and the third battery 130. When the plurality of first batteries 110, the second battery 120, and the third battery 130 are stacked as shown in FIG. 2, the stacked body/combination of the first, second, and third batteries 110, 120, and 130 are inserted into an accommodation space 175 of the housing 170, thereby assembling the battery pack 105.

In FIG. 2, four first batteries 110 are stacked, and each of the first batteries 110 has the same shape as the second battery 120 and the third battery 130. However, the present invention is not limited thereto, that is, the number of the first batteries 110 and the shapes of the batteries may be modified.

Like the embodiment shown in FIG. 1, the housing 170 may be formed of, for example, a metal material, such as aluminum, or may be formed of a plastic material, and the housing 170 surrounds the first, second, and third batteries 110, 120, and 130 of the battery pack 105 to support and protect the first through third batteries 110, 120, and 130. The housing 170 may include a first through hole 71 through which air passes.

Each of the first batteries 110, the second battery 120, and the third battery 130 include first and second terminals 110a, 120a, and 130a, and 110b, 120b, and 130b, respectively.

Referring to FIG. 3, the first terminal 110a and the second terminal 110b are formed on a fourth surface (e.g., front surface in a Y-axis direction) 114 of each first battery 110, the fourth surfaces 114 being exposed and between the second battery 120 and the third battery 130. Alternatively, the first terminal 110a and the second terminal 110b may be formed on a fifth surface (e.g., rear surface in a Y-axis direction) 115 of the each first battery 110.

The first terminals 110a, 120a, and 130a may be electrically connected to each other via a first tab 150a, and the second terminals 110b, 120b, and 130b may be electrically connected to each other via a second tab 150b (see FIG. 2). The number and the shape of the first tab 150a and the second tab 150b that respectively electrically connect the first terminals 110a, 120a, and 130a and the second terminals 110b, 120b, and 130b are not limited to the embodiment shown in FIG. 2, but may be modified variously according to, for example, a magnitude of a voltage supplied by the battery pack 105, or the structure and shape of the battery pack 105.

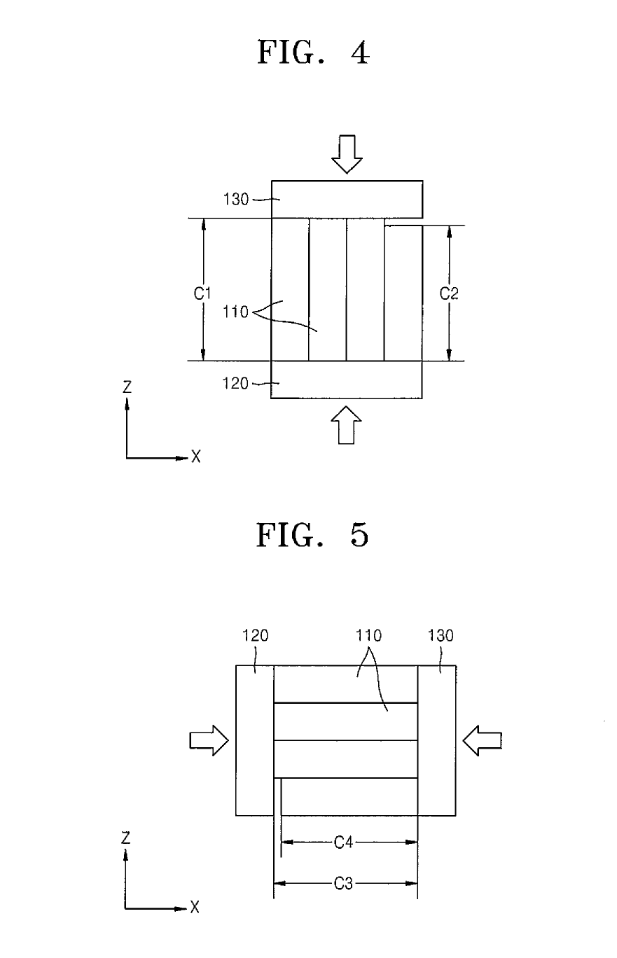

FIG. 4 is a conceptual view showing an operating state of the battery pack 105 shown in FIG. 2, and FIG. 5 is a conceptual view showing another operating state of the battery pack 105 shown in FIG. 2.

According to the battery pack 105 having the above described configuration, the second battery 120 and the third battery 130 contact opposite edges (e.g., the second battery 120 and the third battery 130 respectively contact bottom edges and top edges) of the plurality of first batteries 110 to disperse the loads of the batteries/forces on the battery pack 105. Therefore, when compared to a battery pack that is manufactured by stacking the first batteries 110 only (without the second or third batteries 120, 130), the stacked structure of the first batteries 110, the second battery 120, and the third battery 130 arranged in multiple directions may disperse an external force applied to the battery pack 105.

As shown in FIG. 4, the battery pack 105 may be oriented, or described, in an up-and-down direction (e.g., the first batteries 110 extend in a Z-axis direction) in which gravity is applied, and may receive a load, or force, applied from the up and down direction (as denoted by arrows). If the first battery 110 that is located at a rightmost side of the battery pack 105 is damaged due to the force, a height C2 of that first battery 110 may be reduced to be less than an original height C1 of the other first batteries 110. Even in this case, the contact states between, or positions of, the other first batteries 110 and the second and third batteries 120, 130 are maintained to disperse the applied load, and further damage of the battery pack 105 may be reduced or prevented, thereby maintaining electrical performances of the battery pack 105.

As shown in FIG. 5, the battery pack may be oriented in a horizontal direction (e.g., may be oriented such that the first batteries 110 extend in an X-axis direction) crossing the direction in which the gravity is applied, and may receive the load applied in the horizontal direction denoted by arrows. If the first battery 110 located at a lowermost part of the stacked first batteries 110 is damaged due to the load, a height C4 of the corresponding first battery 110 may be reduced to be less than an original height C3 of the other first batteries 110. Even in this case, the positions/points of contact between the other first batteries 110 and the second and third batteries 120 and 130 are maintained to disperse the applied load, potentially avoiding further/entire damage of the battery pack 105, thereby maintaining electrical performances of the battery pack 105.

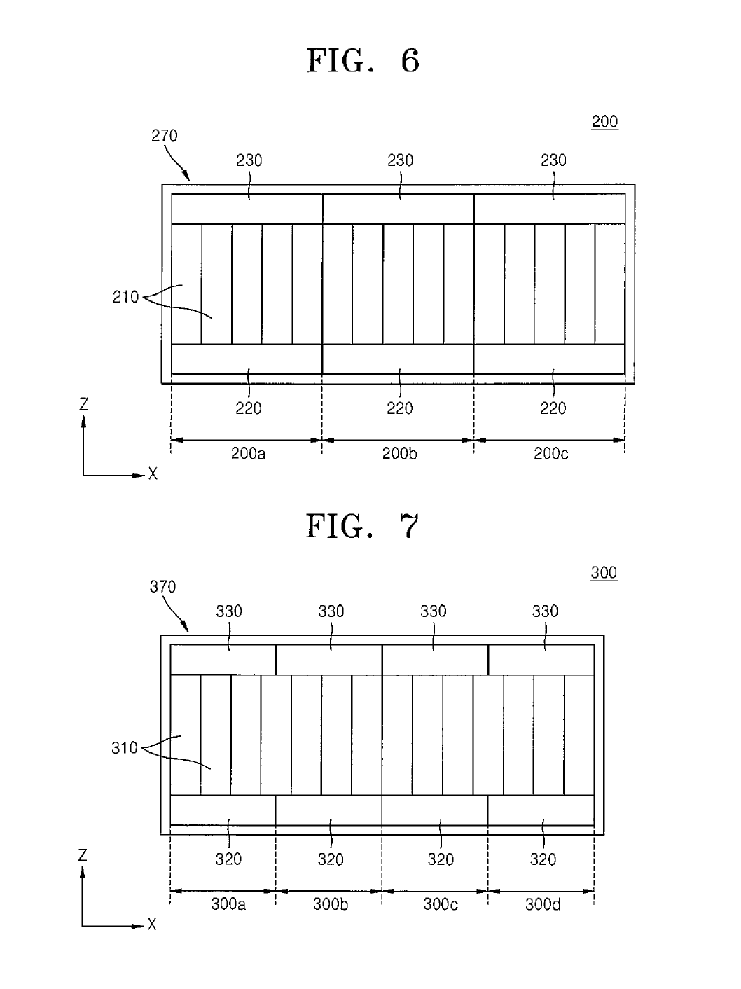

FIG. 6 is a front view schematically showing a battery module 200 according to an embodiment of the present invention. Referring to FIG. 6, the battery module 200 includes a plurality of battery packs 200a, 200b, and 200c, and a housing 270 surrounding the battery packs 200a, 200b, and 200c to support the battery packs 200a, 200b, and 200c.

Each of the battery packs 200a, 200b, and 200c has a similar configuration to the battery packs shown in FIGS. 2 through 5, and a plurality of battery packs 200a, 200b, and 200c are successively/continuously arranged. The battery module 200 may supply a large capacity electric power by supporting the plurality of battery packs 200a, 200b, and 200b by using the housing 270. The number of the battery packs shown in FIG. 6 is an example, and thus, the number of the battery packs may be modified (e.g., may be modified according to a necessary capacity of the electric power or other design specifications).

Each of the battery packs 200a, 200b, and 200c includes a plurality of first batteries 210 that are arranged to contact neighboring ones of the first batteries 210, a second battery 220 contacting first/bottom edges of the first batteries 210, and a third battery 230 contacting second/top edges of the first batteries 210.

A plurality of second batteries 220 and a plurality of third batteries 230 may be arranged in a direction in which the first batteries 210 are arranged (X-axis direction). The first, second, and third batteries 210, 220, and 230 may have the same size and shape as each other.

In FIG. 6, a pair of the second battery 220 and the third battery 230 is located to support five first batteries 210. The second battery 220 and the third battery 230 facing each other may have the same length as each other, and the first batteries 210 may be arranged to be included in lengthwise range of the second and third batteries 220 and 230 in the direction in which the first batteries 210 are arranged (X-axis direction). In other words, the combined width of the first batteries 210 may be less than or equal to the length of the second battery 220 or the third battery 230.

When many batteries are stacked to fabricate a battery module to supply electric power of a large capacity, some of the batteries may be damaged due to a force applied to the battery module. When one or more of the batteries are broken, the force/load applied to the battery module may negatively affect, or impact, the remaining batteries, thereby deforming the entire structure of the battery module, and thereby degrading the electrical performance of the battery module.

In the battery module 200 of the present embodiment, the plurality of battery packs 200a, 200b, and 200c are successively located. However, in each of the battery packs 200a, 200b, and 200c, the second battery 220 and the third battery 230, which extend in a direction that is different from the direction in which the first batteries 210 extend, disperse the load, and accordingly, damage to the rest of the battery module 200, or performance degradation due to the externally applied load, may be reduced or prevented.

FIG. 7 is a front view schematically showing a battery module 300 according to another embodiment of the present invention. The battery module 300 shown in FIG. 7 includes a plurality of battery packs 300a, 300b, 300c, and 300d, and a housing 370 surrounding and supporting the battery packs 300a, 300b, 300c, and 300d.

The plurality of battery packs 300a, 300b, 300c, and 300d are successively arranged. The battery module 300 is assembled so that the housing 370 supports the plurality of battery packs 300a, 300b, 300c, and 300d, and thus, electric power of a relatively large capacity may be supplied.

Each of the battery packs 300a, 300b, 300c, and 300d includes a plurality of first batteries 310 arranged to contact adjacent first batteries 310, a second battery 320 contacting first edges of respective ones of the first batteries 300a through 300d, and a third battery 330 contacting second edges of respective ones of the first batteries 300a through 300d.

A plurality of second batteries 320 and a plurality of third batteries 330 may extend in a direction in which the first batteries 310 are arranged (X-axis direction). The first batteries 310 contacting the second battery 320 and the third battery 330 may partially protrude out of, or extend beyond in the X-axis direction from, the second and third batteries 320 and 330. That is, a portion of the first battery 310 extending past a right end of the leftmost battery pack 300a may be supported by the second battery 320 and the third battery 330 of the adjacent battery pack 300b to the right of the leftmost battery pack 300a.

According to the battery module 300 having the above configuration, the number of the first batteries 310 is not determined by the length of the second battery 320 or the length of the third battery 330, and the number of the second and third batteries 320 and 330 may be adjusted according to the number of the first batteries 310. Thus, there is increased latitude in designing the battery module 300.

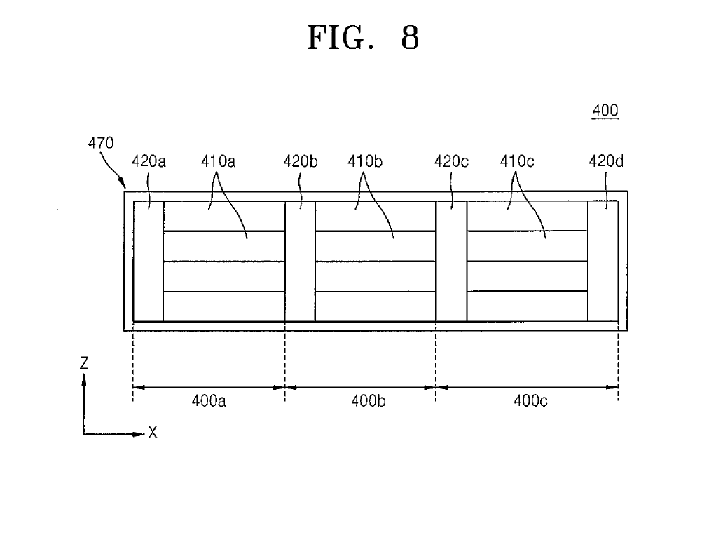

FIG. 8 is a front view schematically showing a battery module 400 according to another embodiment of the present invention. The battery module 400 of FIG. 8 includes a plurality of battery packs 400a, 400b, and 400c, and a housing 470 surrounding and supporting the battery packs 400a, 400b, and 400c.

The battery packs 400a, 400b, and 400c are successively arranged. The battery module 400 is configured so that the plurality of battery packs 400a, 400b, and 400c are supported by the housing 470, and thus, electric power of a large capacity may be supplied.

The battery packs 400a, 400b, and 400c respectively include a plurality of first batteries 410a, 410b, or 410c and a plurality of second batteries 420a, 420b, or 420c.

For example, the first batteries 410b are arranged to contact adjacent first batteries 410b, and to contact the second battery 420b, which contacts first edges of the first batteries 410b. Second edges of the first batteries 410b are supported by/contact the second battery 420c of the adjacent battery pack 400c.

The battery pack 400c from among the plurality of battery packs 400a, 400b, and 400c located at a rightmost side of the battery module 400 includes a third battery 420d contacting the second edges of the first batteries 410c of the rightmost battery pack 400c.

In the battery module 400 having the above configuration, each of the battery packs 400a, 400b, and 400c supports the first batteries 410a, 410b, or 410c of the adjacent battery pack 400a, 400b, or 400c, thereby dispersing the load applied in the X-axis direction between the adjacent battery packs 400a, 400b, and 400c.

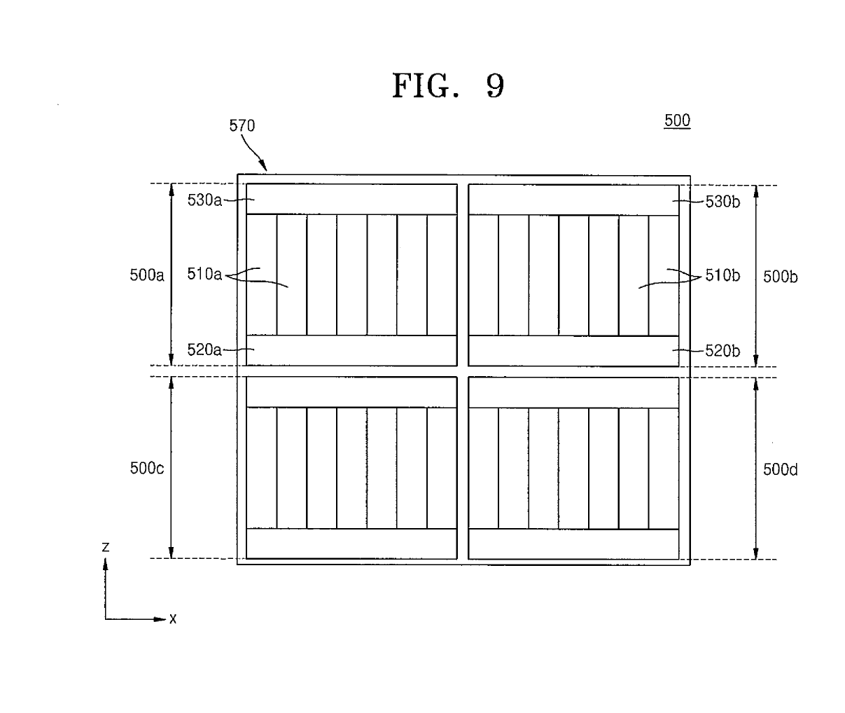

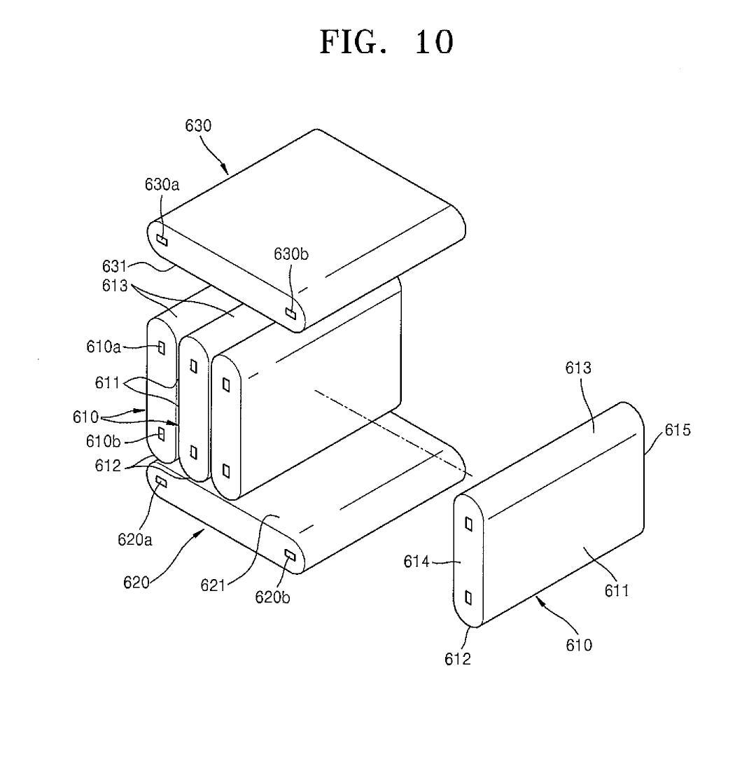

FIG. 9 is a front view schematically showing a battery module 500 according to another embodiment of the present invention. The battery module 500 shown in FIG. 9 includes a plurality of battery packs 500a, 500b, 500c, and 500d, and a housing 570 surrounding and supporting the battery packs 500a, 500b, 500c, and 500d.

A plurality of battery packs 500a, 500b, 500c, and 500d are arranged in the X-axis direction and the Z-axis direction. The battery module 500 is configured so that the housing 570 supports the plurality of battery packs 500a, 500b, 500c, and 500d, and thus, electric power of a large capacity may be supplied.

The battery packs 500a, 500b, 500c, and 500d respectively include a plurality of first batteries (e.g., first batteries 510a or 510b), a second battery (e.g., second battery 520a or 520b) contacting first edges of respective ones of the first batteries 510a and 510b, and a third battery (e.g., third battery 530a or 530b) contacting opposite edges of the first batteries 510a and 510b.

According to the battery module 500 having the above configuration, the plurality of battery packs 500a, 500b, 500c, and 500d are arranged in a two-by-two pattern (e.g., in a two-dimensional way), thereby changing the dimensions of, or reducing, an installation space of the battery module 500, and thereby improving structural stability of the battery module 500.

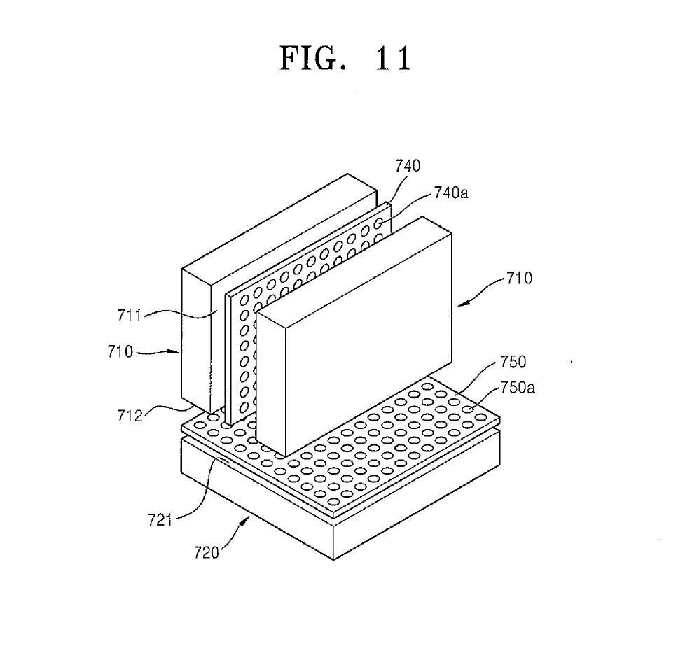

FIG. 10 is an exploded perspective view of a stacking structure of batteries in a battery pack according to another embodiment of the present invention. The battery pack of FIG. 10 includes first batteries 610 arranged so that first/side surfaces 611 thereof may respectively contact each other, a second battery 620 located to contact at least some parts of second/bottom surfaces 612 of the first batteries 610, and a third battery 630 located to contact at least some parts of third/top surfaces 613 of the first batteries 610.

The first batteries 610, the second battery 620, and the third battery 630 have the same size and shape as each other. The second battery 620 includes a surface (e.g., a top surface) 621 extending in a direction in which the first batteries 610 are arranged. The surface 621 of the second battery 620 is one of a pair of the greatest surfaces from among six surfaces of the second battery 620.

The third battery 630 includes a surface (e.g., a bottom surface) 631 extending in a direction in which the first batteries 610 are arranged/successively ordered. The surface 631 of the third battery 630 is one of a pair of the greatest surfaces from among six surfaces of the third battery 630.

The first, second, and third batteries 610, 620, and 630 respectively include first terminals 610a, 620a, and 630a, and second terminals 610b, 620b, and 630b.

Although the first, second, and third batteries 610, 620, and 630 each have six surfaces, unlike the embodiments shown in FIGS. 1 through 9, in which the batteries are formed to have rectangular parallelepiped shapes, the second and third surfaces 612 and 613 of the first batteries 610 are curved.

FIG. 11 is an exploded perspective view of a stacked structure of batteries in a battery pack according to another embodiment of the present invention. The battery pack shown in FIG. 11 includes a plurality of first batteries 710 located so that first surfaces (e.g., side surfaces) 711 thereof may face each other, and a second battery 720 located to face at least parts of second surfaces (e.g., bottom surfaces) 712 of the first batteries 710. A surface (e.g., top surface) 721 of the second battery 720, which is one of the largest surfaces of the second battery 720, faces the second surfaces 712 of the first batteries 710.

Spacers 740 and 750 are located respectively between respective ones of the first batteries 710, and between the first batteries 710 and the second battery 720. Each of the spacers 740 and 750 respectively includes a plurality of through holes 740a or 750a through which air passes.

Each of the spacers 740 and 750 respectively absorbs, or dissipates, heat between respective ones of the first batteries 710, or between the first batteries 710 and the second battery 720, to transfer the heat to an exterior, thereby cooling down the first batteries 710 and the second battery 720 by using the air that may pass through the holes 740 and 750a. The spacers 740 and 750 may also absorb shock, and/or electrically insulate the first batteries 710 and the second battery 720 from each other.

According to the battery pack and the battery module including the battery pack of embodiments of the present invention, the second battery or the third battery disperses the load applied to the first batteries (e.g., disperses the load across the first batteries) by contacting the edges of the first batteries (e.g., the first batteries can effectively collectively disperse a load applied in their lengthwise direction). Therefore, when compared with the battery pack manufactured by stacking the first batteries only, the structure, in which the first batteries are arranged in different directions from the second and third batteries, may disperse the external load applied to the battery pack.

Also, even when one or more of the first batteries is damaged and deformed, contact points and the overall structure of the remaining first batteries to the second and/or third battery may be stably maintained. Therefore, the external load may be dispersed, thereby reducing the likelihood of deformation of the entire structure of the battery pack or the battery module, and thereby maintaining the electrical performance of the battery pack or the battery module.

It should be understood that the exemplary embodiments described herein should be considered in a descriptive sense only, and should not be considered for purposes of limitation. Descriptions of features or aspects within each embodiment should typically be considered as available for other similar features or aspects in other embodiments. While the present invention has been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A battery pack comprising:
a plurality of six-sided first batteries arranged so that first surfaces of neighboring ones of the first batteries contact each other; and
a second battery comprising a surface that extends in a direction in which the first batteries are arranged, and that contacts second surfaces of the first batteries,
wherein the first surfaces of the first batteries have a larger surface area than the second surfaces of the first batteries.

2. The battery pack of claim 1, wherein the second battery comprises six surfaces comprising the surface, and
wherein the surface of the second battery is one of a largest of the six surfaces of the second battery.

3. The battery pack of claim 2, further comprising a third battery contacting third surfaces of the first batteries opposite the second surfaces of the first batteries.

4. The battery pack of claim 3, wherein the third battery comprises six surfaces, and
wherein one of a largest of the six surfaces of the third battery contacts the third surfaces of the first batteries.

5. The battery pack of claim 4, further comprising a conductive tab electrically connected to terminals of the first batteries, the second battery, and the third battery.

6. The battery pack of claim 4, wherein the first batteries each further comprise terminals at a fourth surface or a fifth surface extending between the second surface and third surface.

7. The battery pack of claim 4, further comprising a housing surrounding a part of the first batteries, the second battery, and the third battery.

8. The battery pack of claim 7, wherein the housing comprises a through hole configured to allow air to pass therethrough.

9. The battery pack of claim 1, further comprising a spacer between the neighboring ones of the first batteries, or between the first batteries and the second battery.

10. The battery pack of claim 9, wherein the spacer comprises a through hole configured to allow air to pass therethrough.

11. A battery module comprising:
a plurality of battery packs, each of the battery packs comprising:
a plurality of six-sided first batteries arranged so that first surfaces of neighboring ones of the first batteries contact each other, the first surfaces having a largest area among six surfaces of the first batteries; and
a second battery comprising a surface contacting second surfaces of the first batteries and extending in a direction in which the first batteries are arranged; and
a housing surrounding and supporting the battery packs.

12. The battery module of claim 11, wherein each of the battery packs further comprises a third battery contacting third surfaces of the first batteries that are opposite the second surfaces of the first batteries.

13. The battery module of claim 12, wherein the first batteries, the second battery, and the third battery are similarly dimensioned.

14. The battery module of claim 12, wherein the second and third batteries of neighboring ones of the battery packs extend in a direction in which the first batteries are arranged.

15. The battery module of claim 14, wherein the second battery and the third battery of one of the battery packs have substantially equal lengths in the direction in which the first batteries are arranged, and
wherein a combined width of the first batteries of the one of the battery packs is less than or equal to the lengths of the second and third batteries.

16. The battery module of claim 14, wherein one of the first batteries of one of the battery packs extends past an edge of the second battery or of the third battery of the one of the battery packs, and contacts the second battery or the third battery of an adjacent one of the battery packs.
